(19) United States
(12) Patent Application Publication
(10) Pub. No.: US 2026/0205045 A1
(43) Pub. Date: Jul. 16, 2026

(54) METHOD FOR OPERATING AN ELECTRIC MOTOR

(71) Applicant: Schaeffler Technologies AG & Co. KG, Herzogenaurach (DE)

(72) Inventors: Erhard HODRUS, Achern (DE); Christian Eberle, Buhl (DE); Alexander Rosch, Achern (DE)

(73) Assignee: Schaeffler Technologies AG & Co. KG, Herzogenaurach (DE)

(21) Appl. No.: 19/136,097

(22) PCT Filed: Nov. 9, 2023
(86) PCT No.: PCT/DE2023/100845

§ 371 Date: Jun. 5, 2025

(30) Foreign Application Priority Data
Dec. 6, 2022 (DE) 10 2022 132 309.9

(51) Int. Cl. H02P 29/028; H02P 6/16; H02P 6/18; H02P 6/24

(52) U.S. Cl. CPC H02P 29/028; H02P 6/16; H02P 6/183; H02P 6/24; H02P 2203/05; H02P 2203/11

(57) ABSTRACT

A method for operating an electric motor having a stator and a rotor that can rotate relative to said stator while varying a rotor position, and a rotor position sensor for determining the rotor position, wherein injection signals are also used to estimate the rotor position, wherein if the rotor position sensor fails or if a rotor position sensor error is detected, the electric motor continues to be operated without a rotor position sensor using the estimated rotor position.

### CROSS-REFERENCE TO RELATED APPLICATIONS

This application is the U.S. National Phase of PCT Appln. No. PCT/DE 2023/100845, filed Nov. 9, 2023, which claims the benefit of German Patent Appln. No. 102022132309.9, filed Dec. 6, 2022, the entire disclosures of which are incorporated by reference herein.

### TECHNICAL FIELD

The present disclosure relates to a method for operating an electric motor having a stator and a rotor that can be rotated relative to said stator while varying a rotor position.

### BACKGROUND

Nowadays, it is hard to imagine vehicles without electric motors. In principle, there are three alternative approaches: use of a PMSM (permanently excited synchronous machine), separately excited synchronous machines and the asynchronous machine. When using a PMSM, the electric motor can be very compact with a high power density. Compared to the separately excited synchronous machine and the asynchronous machine, this is achieved by using strong permanent magnets in the rotor.

WO 2021 043 361 A1 discloses a method for calculating the temperature in the event of a failure of the temperature sensor in the stator of an electric motor. For this purpose, an observer is designed based on a linear time-invariant temperature model (LTI model), which estimates the temperatures.

The as yet unpublished German patent application DE 10 2022 124 162.9 discloses a method for operating an electric motor without a rotational direction sensor comprising a stator and a rotor, wherein injection signals are used to determine the rotational speed of the electric motor, and the rotational direction of the electric motor is determined.

When an electric motor is operated without rotational direction sensors, the rotor position sensor, which is usually used to determine the current angle of the rotor, is omitted. Current sensor signals and measured or estimated phase voltages are used to determine the rotor position and speed of the motor via a model. Below a rotational speed threshold of the absolute rotational speed, it is necessary to feed in what are termed injection signals, which support the identification of the rotor position and the speed in this rotational speed range.

Starting with a stationary rotor, the rotor position must be determined by an initialization routine. With the injection methods, the motor can be operated in the lower rotational speed range until, for example, a switch to a model-based sensorless algorithm takes place.

The initial rotor position can be determined by specifying an alternating voltage excitation, a high-frequency oscillation in d- and q-voltage, for a certain number of points on a voltage circuit path, in which the exciting voltage amplitude leads to a resulting current amplitude. Owing to the d-q coordinates, an ellipse in the d-q plane in the current must be formed in the case of a circular excitation in the voltage. The main axis of the ellipse corresponds to the d-direction. This direction of the main axis describes the initial value of the rotor position.

In the as yet unpublished German patent application DE 10 2022 110 304.8, it is proposed to find the longer main axis of the ellipse, which corresponds to the d-axis, by means of an iterative controller approach. By applying the injection signal on the voltage, a current can be measured.

The encoderless operation of a permanent magnet-excited synchronous machine must be carried out with an injection signal at low absolute rotational speeds. However, the injection signal can also be used in the whole working range, as shown, for example, in the as yet unpublished German patent application DE 10 2022 118 125.1. The anisotropy of the motor is evaluated because the inductances in the q and d directions are different (Lq not equal to Ld). Especially in small motors, the magnets are often glued on, so the differences in inductance are small.

In the context of the present document, the terms “rotor position sensor”, “rotor position encoder”, and “rotational position encoder” are used with identical meaning. The same applies to the terms “without a rotor position sensor”, “without a rotor position encoder” and “without a rotational position encoder”.

When operating the PMSM, there are a few things to bear in mind. The rotor with the permanent magnet must not become too hot during operation, and the magnetic field generated by the electromagnets of the stator must not be so strong that the magnetization of the permanent magnet is altered.

The magnetic field strength generated by the stator is directly related to the current flowing through the windings of the electromagnets. The higher the current, the higher the induced magnetic field, which then acts on the permanent magnets of the rotor.

One source of very high currents is the special situation when switching from normal operation to active short circuit. This is carried out, for example, when an error is detected. Although these very high currents often dissipate very quickly, the brief, very strong magnetic fields can be harmful to the motor and permanently partially demagnetize the permanent magnets. This then leads to a loss of performance and efficiency for the remaining service life of the motor. FIG. 1 shows the high current peaks at the beginning of an active short circuit.

In electric motors on the test bench, with slightly more frequent shutdowns by means of active short circuits, a degradation of the permanent magnet of 20% could be observed in a short time period due to the frequent occurrence of the special situations. For driving operation, 1-3% over the service life is currently assumed and is usually reserved in a design.

The permanent magnet of an electric motor can be demagnetized by high currents in the windings of the electromagnets of the motor and thus permanently damaged. As a result, the electric motor has less magnetic force, which has a very adverse effect on the efficiency and controllability of the motor.

### SUMMARY

The disclosure is based on the object of targetedly avoiding situations that could potentially lead to the demagnetization of the permanent magnet.

In a method according to the disclosure for operating an electric motor having a stator and a rotor that can be rotated relative to said stator while varying a rotor position, and a rotor position sensor for determining the rotor position, wherein injection signals are also used to estimate the rotor position, if the rotor position sensor fails or if a rotor position sensor error is detected, the electric motor continues to be operated without a rotor position sensor using the estimated rotor position.

In a preferred embodiment of the disclosure, the electric motor continues to be operated without a rotor position sensor using the estimated rotor position by braking the electric motor.

In a particularly preferred embodiment of the disclosure, it is provided that the continued operation and/or braking of the electric motor takes place by means of controlling without a rotor position sensor.

In a further preferred embodiment of the disclosure, the electric motor is braked by means of the control without a rotor position sensor instead of an actively induced short circuit if the rotor position sensor fails or if a rotor position sensor error is detected.

In a further preferred embodiment of the disclosure, it is provided that the rotor position determined by means of the rotor position sensor and the rotor position estimated by means of the injection signals are compared with each other. If the rotor position sensor does not indicate an error, its rotor position value is also used for the estimated rotor position.

In a further particularly preferred embodiment of the disclosure, when the electric motor is braked by means of the control without a rotor position sensor, voltage is applied which counteracts the rotational direction of the rotor.

In a further preferred embodiment of the disclosure, when the electric motor is braked by means of the control without a rotor position sensor, voltage is applied which counteracts the rotational direction of the rotor and causes a predetermined braking torque on the rotor.

In a further preferred embodiment of the disclosure, when the electric motor is braked by means of the control without a rotor position sensor, a voltage is applied which causes a zero torque on the rotor.

In a further preferred embodiment of the disclosure, a field weakening is carried out to cause the zero torque on the rotor. Field weakening is particularly effective at higher rotational speeds.

In a further preferred embodiment of the disclosure, if the rotor position sensor fails or if a rotor position sensor error is detected, the electric motor continues to be operated by means of the control without a rotor position sensor and a driver warning is activated.

In this way, situations that could potentially lead to demagnetization of the permanent magnet can be advantageously avoided.

Further advantages and advantageous embodiments of the disclosure are subject matter of the following figures and their description.

### BRIEF DESCRIPTION OF THE DRAWINGS

In the drawings, in particular:

FIG. 1 shows high current peaks at the beginning of an active short circuit.

### DETAILED DESCRIPTION

Requesting an active short circuit due to a failure of the rotational position encoder—also referred to identically in the present document as the rotor position sensor or rotor position encoder—of the motor should be prevented by using a backup strategy. The backup strategy involves control of the electric motor without a rotor position encoder, since this allows the electric motor to be controlled even without a rotational position encoder.

In normal operation, the electric motor is usually only operated with the rotor position encoder. At the same time, according to the disclosure, the control without a rotor position sensor is intended to continuously determine a rotor position angle. If a rotor position encoder error is detected, the motor is braked in a controlled manner in one embodiment of the disclosure using the estimated rotor position signal of the control without a rotor position sensor instead of initiating an active short circuit. Braking simulates the behavior of the active short circuit. With actively controlled braking, the motor can be brought to a standstill more quickly by applying voltages that counteract the rotational direction than by the active short circuit.

In both cases, the motor can be braked by actively short-circuiting and deliberately controlling the braking of the motor using the rotor position signal from the sensorless control.

The difference lies in the current peaks that occur briefly and very strongly, especially at the start of the active short circuit. This can be avoided with selectively controlled braking, as the PWM pattern is no longer stopped abruptly without taking into account the energy stored in the motor coils and in the magnetic field of the motor.

This results in encoderless control as a backup strategy to avoid unnecessary special situations, such as an active short circuit.

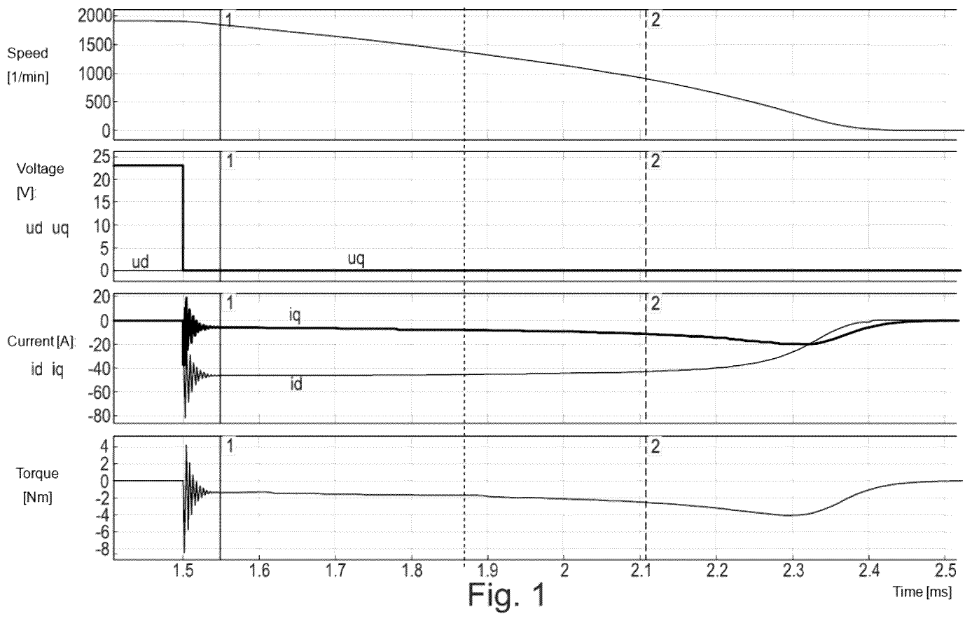

FIG. 1 shows the active short circuit. The two voltages ud and uq can be clearly seen, which disappear even though the rotational speed is still high. This causes strong current peaks. These in turn can lead to demagnetization of the permanent magnets.

In the controlled case according to the disclosure with the estimated rotor position signal without a rotor position sensor, the peaks are not to be expected. There is no risk of demagnetization.

The presence of a rotor position sensor can be used in normal operation to compare the angle of the control without a rotor position sensor with the angle of the rotor position encoder. The parameters of the control without a rotor position sensor can thus be adjusted to the ageing effects of the motor.

As an alternative to the known emergency mode of braking the motor when the special situation occurs, as is currently the case with the active short circuit, it is also possible to consider moving the vehicle normally and switching on the malfunction lamp as a driver warning.

In addition, the driving strategy can also achieve a different behavior in the special situation with sensorless operation: Consideration can also be given to providing a targeted zero torque with any necessary field weakening at high rotational speeds.

A defined braking torque can also be set, different from the undesired braking torque of an active short circuit.
1. A method for operating an electric motor having a stator and a rotor that can be rotated relative to said stator while varying a rotor position, and a rotor position sensor for determining the rotor position, wherein additionally the method comprising: using injection signals are used to estimate the rotor position, characterized in that, and using the estimated rotor position to continue to operate the electric motor if the rotor position sensor fails or if a rotor position sensor error is detected, the electric motor continues to be operated without a rotor position sensor using the estimated rotor position.
2. The method according to claim 1, characterized in that wherein using the estimated rotor position to continue to operate the electric motor if the rotor position sensor fails or if a rotor position sensor error is detected further includes braking the electric motor continues to be operated without a rotor position sensor using the estimated rotor position in that the electric motor is braked.
3. The method according to any one of claims 1 or 2, characterized in that claim 2, wherein the continued operation without a rotor position sensor and/or the braking of the electric motor take(s) place by means of is performed by control without a rotor position sensor.
4. The method according to any one of claims 1 to 3, characterized in that claim 3, wherein the braking of the electric motor takes place by means of the is performed by control without a rotor position sensor instead of an actively induced short circuit if the rotor position sensor fails or if a rotor position sensor error is detected.
5. The method according to any one of the preceding claims 1 to 4, characterized in that claim 4, wherein the rotor position determined by means of the rotor position sensor and the rotor position estimated by means of the injection signals are compared with each other.
6. The method according to any one of the preceding claims 3 to 5, characterized in that claim 5, wherein, when the electric motor is braked by means of the control without a rotor position sensor, voltage is applied which counteracts the rotational direction of the rotor.
7. The method according to any one of the preceding claims 3 to 6, characterized in that claim 6, wherein, when the electric motor is braked by means of the control without a rotor position sensor, voltage is applied which counteracts the rotational direction of the rotor and causes a predetermined braking torque on the rotor.
8. The method according to any one of the preceding claims 3 to 6, characterized in that claim 6, wherein, when the electric motor is braked by means of control without a rotor position sensor, a voltage is applied which causes a zero torque on the rotor.
9. The method according to claim 8, characterized in that wherein a field weakening is carried out to cause the zero torque on the rotor.
10. The method according to claim 1, characterized in that wherein, if the rotor position sensor fails or if a rotor position sensor error is detected, the electric motor continues to be operated by means of the control without a rotor position sensor and a driver warning is activated.
11. The method according to claim 2, wherein using the estimated rotor position to continue to operate the electric motor if the rotor position sensor fails or if a rotor position sensor error is detected further includes control without a rotor position sensor.
12. The method according to claim 11, wherein the rotor position determined by the rotor position sensor and the rotor position estimated by the injection signals are compared with each other.
13. The method according to claim 12, wherein a field weakening is carried out to cause the zero torque on the rotor.
14. The method according to claim 11, wherein, if the rotor position sensor fails or if a rotor position sensor error is detected, the electric motor continues to be operated by control without a rotor position sensor and a driver warning is activated.

1. A method for operating an electric motor having a stator and a rotor that can be rotated relative to said stator while varying a rotor position, and a rotor position sensor for determining the rotor position, the method comprising: using injection signals to estimate the rotor position, and using the estimated rotor position to continue to operate the electric motor if the rotor position sensor fails or if a rotor position sensor error is detected.

2. The method according to claim 1, wherein using the estimated rotor position to continue to operate the electric motor if the rotor position sensor fails or if a rotor position sensor error is detected further includes braking the electric motor.

3. The method according to claim 2, wherein the braking of the electric motor is performed by control without a rotor position sensor.

4. The method according to claim 3, wherein the braking of the electric is performed by control without a rotor position sensor instead of an actively induced short circuit if the rotor position sensor fails or if a rotor position sensor error is detected.

5. The method according to claim 4, wherein the rotor position determined by the rotor position sensor and the rotor position estimated by the injection signals are compared with each other.

6. The method according to claim 5, wherein, when the electric motor is braked by control without a rotor position sensor, voltage is applied which counteracts the rotational direction of the rotor.

7. The method according to claim 6, wherein, when the electric motor is braked by control without a rotor position sensor, voltage is applied which counteracts the rotational direction of the rotor and causes a predetermined braking torque on the rotor.

8. The method according to claim 6, wherein, when the electric motor is braked by control without a rotor position sensor, a voltage is applied which causes a zero torque on the rotor.

9. The method according to claim 8, wherein a field weakening is carried out to cause the zero torque on the rotor.

10. The method according to claim 1, wherein, if the rotor position sensor fails or if a rotor position sensor error is detected, the electric motor continues to be operated by control without a rotor position sensor and a driver warning is activated.

11. The method according to claim 2, wherein using the estimated rotor position to continue to operate the electric motor if the rotor position sensor fails or if a rotor position sensor error is detected further includes control without a rotor position sensor.

12. The method according to claim 11, wherein the rotor position determined by the rotor position sensor and the rotor position estimated by the injection signals are compared with each other.

13. The method according to claim 12, wherein a field weakening is carried out to cause the zero torque on the rotor.

14. The method according to claim 11, wherein, if the rotor position sensor fails or if a rotor position sensor error is detected, the electric motor continues to be operated by control without a rotor position sensor and a driver warning is activated.
